(19) United States
(12) Patent Application Publication
(10) Pub. No.: US 2007/0073948 A1
(43) Pub. Date: Mar. 29, 2007

(54) Bus control system

(75) Inventor: Hitoshi Hamao, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/522,380

(22) Filed: Sep. 18, 2006

(30) Foreign Application Priority Data
Sep. 26, 2005 (JP) 2005-277298

(51) Int. Cl. G06F 13/00

(52) U.S. Cl. 710/110

(57) ABSTRACT

A bus control system includes bus masters connected to a common bus and a bus slave for transferring data with one bus master by arbitration. The bus control system further includes a live-lock controller connected to the bus slave and controlling the data transfer. The live-lock controller counts a retry response to one bus master and sets priority for preferentially accepting an access request from this bus master according to the count value. When the live-lock controller receives an access request from the other bus master, it sends a retry response to that bus master.

### BACKGROUND OF THE INVENTION

1. Field of the Invention

The present invention relates to a bus control system and particularly to a bus control system which is connected to a peripheral circuit inside an LSI.

2. Description of Related Art

A common bus system transfers data through a common bus. In the common bus system, it is impossible for a plurality of devices to use a single common bus at the same time. Therefore, a bus arbiter is used to perform arbitration for allowing a plurality of devices to time-share the use of a common bus when bus use requests are made simultaneously from the plurality of devices. There are various arbitration methods using such a bus arbiter, including cyclic bus arbitration in which a bus use priority right is assigned to each device in regular cyclic fashion. In the following description, devices that can obtain a bus use right for using a common bus is referred to as a bus master, and a device to receive data transferred from the bus master is referred to as a bus slave.

A bus arbiter, a plurality of bus master, and bus slaves are commonly connected to a single common bus. A bus master designates a bus slave by outputting an address onto the common bus and transfers data with the designated bus slave through the common bus. Specifically, when a bus master transfers data to a bus slave, the bus master initially makes a request for a bus use right to the bus arbiter. The bus arbiter arbitrates the requests for a bus use right sent from a plurality of bus masters and grants a bus use right to one selected bus master. The bus master that obtains the bus use right is now able to transfer data to the bus slave.

If the bus slave is in the condition that is able to accept an access request from the bus master, it accepts the access request and typically sends back an OK response to the bus master. If, on the other hand, the bus slave is in the condition that is unable to accept the access request from the bus master immediately for some reasons, it sends back a RETRY response to the bus master in order to prevent the bus mater from needlessly occupying the bus. Receiving the RETRY response, the bus master loses the bus use right once so that another bus master can transfer data through the bus. The bus master that has lost the bus use right again makes a request for a bus use right to the bus arbiter and retries sending an access request to the same bus slave.

FIGS. 11A to 11D illustrate the use of such a common bus. As shown in FIG. 11A, bus masters 111 and 112 which possess a bus use right can send an access request to a bus slave 121.

Referring to FIG. 11B, if the bus master 111 which possesses the bus use right sends an access request to the bus slave 121, the bus slave 121, which is in processable condition, deals with the access request from the bus master 111 (Process 1).

Referring then to FIG. 11C, if the bus master 112 which possesses the bus use right then sends an access request to the bus slave 121, the bus slave 121, which is under processing and thus unable to accept the access request, sends a RETRY response to the bus master 112 (Process 2).

Referring further to FIG. 11D, if the processing in the bus slave 121 completes and enters processable condition, the bus use right is passed on from the bus master 112 to the bus master 111, and the bus master 112 again sends an access request to the bus slave 121. Because the buss slave 121 is now in processable condition, it accepts the access request from the bus master 112 (Process 3).

If the operation of Processes 1 and 2 respectively shown in FIGS. 11B and 11C occurs repeatedly, it follows as a consequence that the bus slave 121 accepts only the access from the bus master 111 and the bus master 112 cannot transfer data as shown in FIG. 12.

FIG. 12 illustrates a case where the bus masters 111 and 112 alternatively send an access request to the bus slave 121 and, when the bus master 112 intends to access the bus slave 121, the bus slave 121 is always in the process of performing the processing based on the request from the bus master 111. In the example of FIG. 12, a WRITE request, which is indicated by “W” in the figure, is made from the bus master.

As shown in FIG. 12, there is a possibility that the bus transaction falls into a periodic pattern in which an access request from a specific bus master only is processed and any access request from other bus masters is not processed. Such a condition, where as if the bus is locked, is called “live-lock”, which is one of unsuitable matters in the bus transaction.

An example of a bus arbiter for preventing live-lock is disclosed in Japanese Unexamined Patent Publication No. 2000-315188. An exemplary configuration of the bus arbiter according to this technique is described hereinafter with reference to FIG. 13. FIG. 13 is a block diagram showing an example of the configuration of the bus arbiter disclosed in the above related art.

As shown in FIG. 13, a bus transaction detector 902 and a live-lock detector 903 are disposed in the vicinity of an arbiter 901 that serves as an arbitration circuit. The bus transaction detector 902 and the live-lock detector 903 monitor the transaction on the bus 110 and detect the bus master 111 that is constantly in the RETRY state.

The live-lock detector 903 detects that the bus transaction is in live-lock when a value set to a threshold register 904 and the number of RETRY attempts match. If the live-lock condition is detected, a bus exclusive mode detector 905 grants an exclusive use right of the bus 110 to the locked bus master 111. The bus master 111 under the live-lock condition can thereby transfer data to the target bus slave 121 without being affected by the other bus master 112.

An arbitration method for a common bus is disclosed in Japanese Unexamined Patent Publication No. 4-192056, for example. In the bus arbiter disclosed therein, if a specific bus master accesses a bus slave with a slow response, an access controller sends a RETRY response to the bus master. At the same time, the access controller outputs a bus request inhibiting signal for the bus master. While the bus request inhibiting signal is asserted, even if the bus master makes a bus use request to the arbiter, the bus use request from this bus master is not input to the bus arbiter. The bus request inhibiting signal is released when the bus slave makes a response.

However, the present invention has recognized that the conventional techniques have the followings problems. In the bus arbiter 901 disclosed in Japanese Unexamined Patent Publication No. 2000-315188, even if an exclusive bus use right is granted to the bus master 111 that is determined to be in live-lock, a RETRY response can occur if the target bus slave 121 is still in processing. Because the bus use right is exclusively possessed by the live-locked bus master 111, the bus master 112 which intends to access a bus slave 122 or a bus slave 123 cannot use the bus, resulting in reduction in transfer efficiency.

Further, even if the bus master 112 is such a bus master that can refrain from transferring data for a certain period of time as system structure, the threshold register 904 sets the same threshold to the bus master 112 as the threshold set to the bus master 111. This reduces the transfer efficiency between the bus masters 111 and 112 and the bus slave. 121 to deteriorate system performance consequently.

The arbitration method disclosed in Japanese Unexamined Patent Publication No. 4-192056 is a technique that does not accept the bus use request for accessing a specific bus slave with a slow response until a response occurs from this bus slave. This technique, however, cannot prevent live-lock depending on timing when a bus use request is made from a bus master.

As described in the foregoing, the bus arbiter according to the related arts cannot effectively prevent live-lock or causes reduction in transfer efficiency of a system even if live-lock is prevented.

### SUMMARY OF THE INVENTION

According to an aspect of the present invention, there is provided a bus control system including a plurality of bus masters connected to a common bus, a bus slave transferring data with the plurality of bus masters through the common bus, and a controller counting a retry response to each of the plurality of bus masters for the respective bus masters and setting priority for preferentially accepting an access request from a selected bus master according to a count value.

According to another aspect of the present invention, there is provided a bus control system including a first bus master and a second bus master connected to a common bus, a bus slave transferring data with the first bus master or the second bus master through the common bus, and a controller connected to the bus slave, controlling the transfer of data, the controller counting a retry response to the first bus master and sets priority for preferentially accepting an access request from the first bus master according to a count value, and, upon receipt of an access request from the second bus master when the priority is set to the first bus master, sending a retry response to the second bus master.

### BRIEF DESCRIPTION OF THE DRAWINGS

The above and other objects, advantages and features of the present invention will be more apparent from the following description taken in conjunction with the accompanying drawings, in which:

FIG. 1A is a schematic view to describe a bus control system according to an embodiment of the present invention;

FIG. 1B is a schematic view to describe a bus control system according to the embodiment of the present invention;

FIG. 1C is a schematic view to describe a bus control system according to the embodiment of the present invention;

FIG. 2 is a block diagram showing an example of the configuration of a bus control system according to an embodiment of the present invention;

FIG. 3 is a block diagram showing an example of threshold setting in a bus control system according to an embodiment of the present invention;

FIG. 4 is a block diagram showing another example of threshold setting in a bus control system according to an embodiment of the present invention;

FIG. 5 is a timing chart showing an example of operation in a bus control system according to an embodiment of the present invention;

FIG. 6 is a timing chart showing live-lock condition in a bus control system according to an embodiment of the present invention;

FIG. 7 is a timing chart showing live-lock condition in a bus control system according to a related art;

FIG. 8 is a block diagram showing another example of the configuration of a bus control system according to an embodiment of the present invention;

FIG. 9 is a timing chart showing another example of operation in a bus control system according to an embodiment of the present invention;

FIG. 10 is a block diagram showing yet another example of the configuration of a bus control system according to an embodiment of the present invention;

FIG. 11A is a schematic view to describe live-lock condition in a bus control system according to a related art;

FIG. 11B is a schematic view to describe live-lock condition in a bus control system according to the related art;

FIG. 11C is a schematic view to describe live-lock condition in a bus control system according to the related art;

FIG. 11D is a schematic view to describe live-lock condition in a bus control system according to the related art;

FIG. 12 is a timing chart showing an example of operation in a bus control system according to a related art; and

FIG. 13 is a block diagram showing an example of the configuration of a bus control system according to a related art.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A bus control system according to embodiments of the present invention includes and controls a bus master circuit that requests a bus use right to a bus system and transfers data to another circuit, and a bus slave circuit.

Exemplary embodiments of the present invention are described hereinafter with reference to the drawings.

First Embodiment

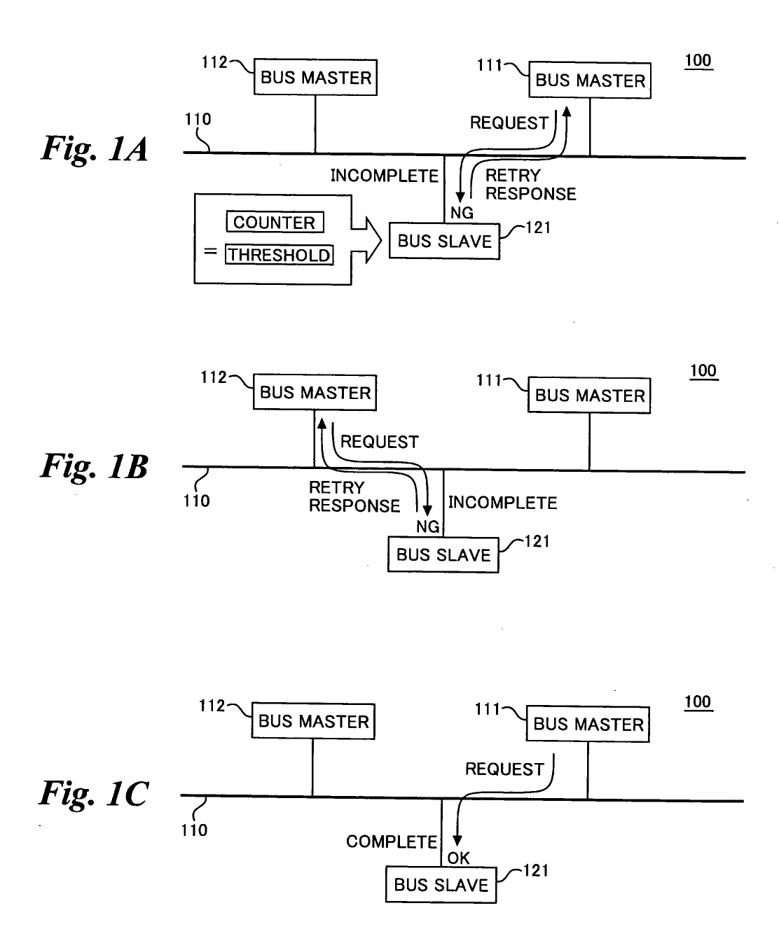

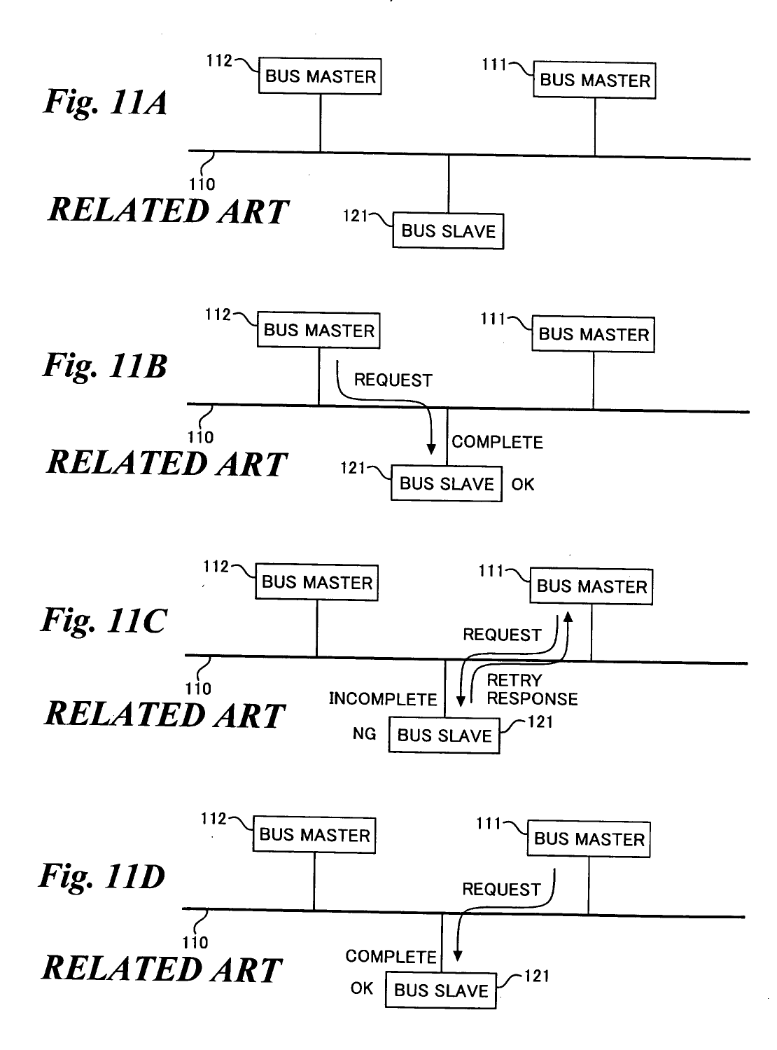

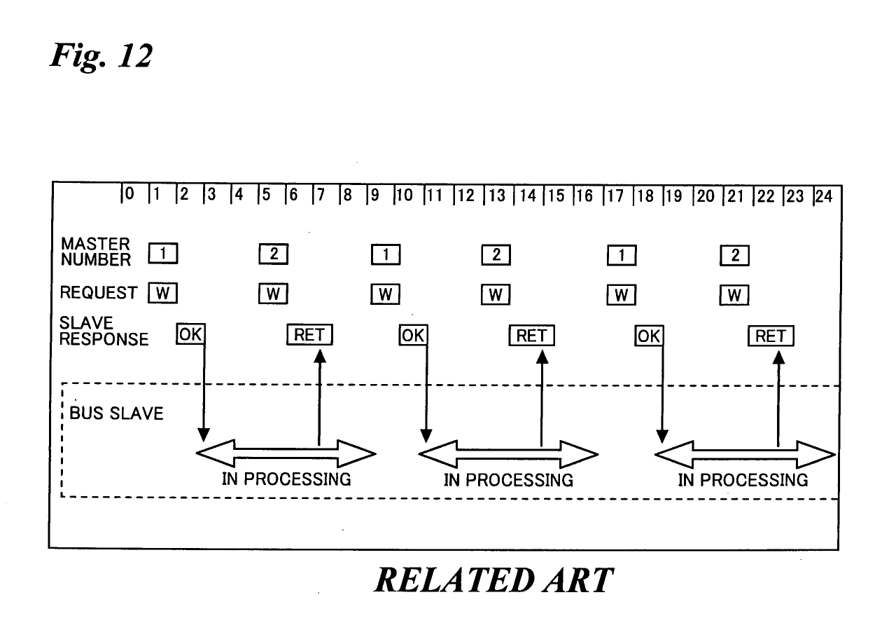

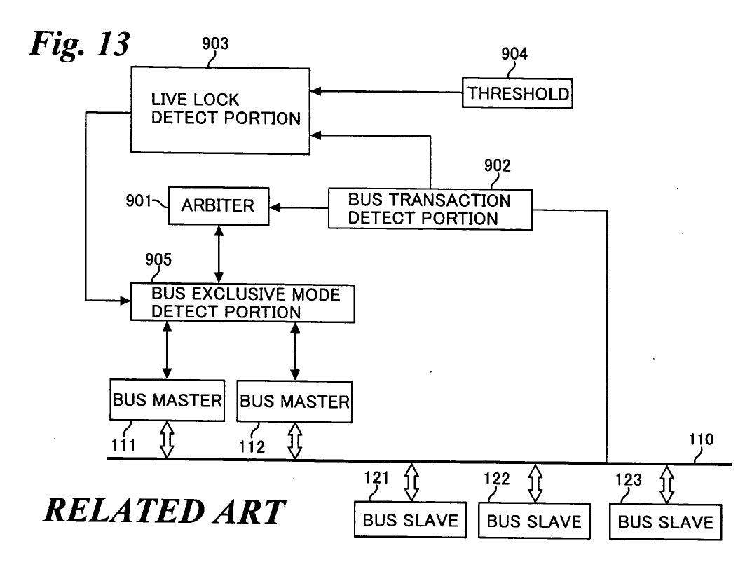

A brief summary of a bus control system according to an embodiment of the present invention is described hereinafter with reference to FIGS. 1A to 1C. FIGS. 1A to 1C are views to schematically describe the bus control system of this embodiment. In this bus control system, the following processes are performed in addition to the normal Processes 1 to 3 described earlier with reference to FIGS. 11A to 11D.

Referring first to FIG. 1A, in a bus control system 100 of this embodiment, a bus master 111 makes an access request to a bus slave 121 through a bus 110. For example, if the bus slave 121 is processing data based on the request from a bus master 112, the bus slave 121 cannot accept data from the bus master 111. The bus slave 121 counts up a retry counter for the bus master 111 which is disposed inside the bus slave 121 and, if the counter value exceeds a threshold, determines that the bus master 111 is live-locked. The bus slave 121 then sets priority to the bus master 111.

Referring then to FIG. 1B, after the bus slave 121 completes the processing and enters the processable state, both of the bus masters 111 and 112 can make an access request for the bus slave 121. For example, the bus master 112 makes an access request for the bus slave 121, and the bus master 112 requests for an access to the bus slave 121. Though the bus slave 121 is in the processable state at this time, because priority is set to the bus master 111, the bus slave 121 sends back a RETRY response to the bus master 112.

Referring further to FIG. 1C, the bus use right is passed on from the bus master 112 to the bus master 111, and the bus master 111 requests for an access to the bus slave 121. The bus slave 121 accepts the access request from the bus master 111 which possesses priority.

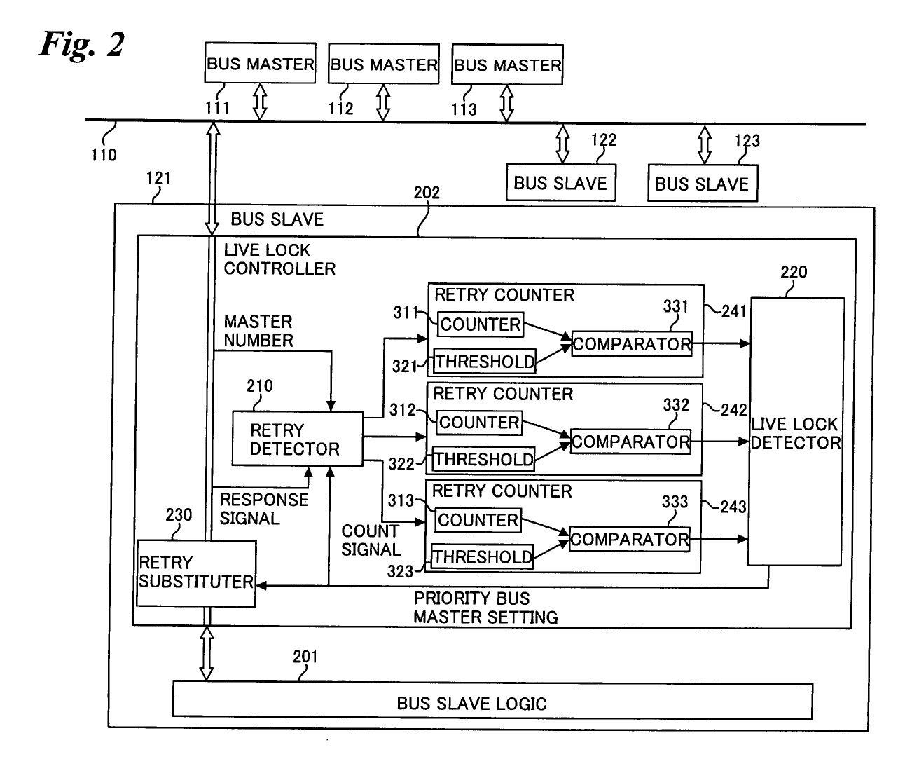

Referring now to FIG. 2, the bus slave 121 of the bus control system 100 according to this embodiment is described in detail hereinafter.

The bus slave 121 includes a bus slave logic 201 and a live-lock controller 202.

The bus slave logic 201 is composed of a logic main body having a primary bus slave function. The live-lock controller 202 controls an access request in order to prevent live-lock. Specifically, the live-lock controller 202 counts the number of RETRY attempts for each bus master and preferentially gives permission for data transfer to the bus slave logic 201 to one of the bus masters 111 to 113 which is regarded as being live-locked according to the count value.

Referring still to FIG. 2, the live-lock controller 202 of the bus slave 121 according to this embodiment is described in detail hereinafter.

The live-lock controller 202 includes a retry detector 210, a live-lock detector 220, a retry substituter 230, and retry counters 241, 242 and 243. The live-lock controller 202 has the same number of retry counters as the number of bus masters. Thus, the number of bus masters and the number of retry counters are equal.

The retry detector 210 receives a bus master number that is input to the bus slave 121 from the bus masters 111 to 113. In addition, the retry detector 210 receives a response signal for the bus master number. The response signal is either an OK response indicating that an access from the bus masters 111 to 113 to the bus slave 121 is allowed or a RETRY response indicating that the access is not allowed.

If the retry detector 210 receives a RETRY response from the bus slave logic 201, it outputs a count signal to the retry counter 241 to 243 corresponding to the relevant bus master. If, on the other hand, the retry detector 210 receives an OK response from the bus slave logic 201, it outputs a reset signal to the retry counter 241 to 243 corresponding to the relevant bus master.

The live-lock detector 220 determines which of the retry counters 241 to 243 has output the signal. According to the determination results, the live-lock detector 220 implements priority bus master setting (which is also referred to simply as the priority setting) on the bus slave 121 for giving priority to the request of the relevant bus master 111, 112 or 113.

The live-lock detector 220 releases the priority setting of the relevant bus master 111, 112 or 113 when the input signal from the retry counter 241, 242 or 243 stops. The retry detector 210 does not output a count signal while the priority setting is supplied from the live-lock detector 220.

The retry substituter 230 operates only when the priority bus master setting is on. In other times, it lets the requests from the bus masters 111 to 113 through to the bus slave 121. Specifically, if the priority bus master setting is on, the retry substituter 230 sends a RETRY response on behalf of the bus slave logic 201 in response to the request from the bus master 111, 112 or 113 to which priority is not set.

If the bus master 111, 112 or 113 that does not possess priority makes an access request, the retry substituter 230 masks the access request to the bus slave 121 so that the occurrence of the access request is not notified to the bus slave logic 201. On the other hand, if the bus master 111, 112 or 113 which possesses priority makes an access request, the retry substituter 230 sends the access request to the bus slave logic 201.

The retry counters 241 to 243 respectively include counters 311, 312 and 313, threshold registers 321, 322 and 323, and comparators 331, 332 and 333 as a set of unit.

The counters 311 to 313 count up according to the count signal output from the retry detector 210. If a count value reaches a threshold, the counters 311 to 313 maintain the count value until it is reset. The counters 311 to 313 clear the counter upon receipt of a reset signal from the retry detector 210.

In the threshold registers 321 to 323, a threshold is preset for each of the bus masters 111 to 113.

The comparators 331 to 333 compare a count value with the threshold. When the two values match, the comparators 331 to 333 send a signal to the live-lock detector 220.

The setting of a threshold to the threshold registers 321 to 323 of the retry counters 241 to 243 is described hereinafter. A threshold set to the threshold registers 321 to 323 may be set internally or externally. A set value may be rewritable by software or other means or may be a fixed number.

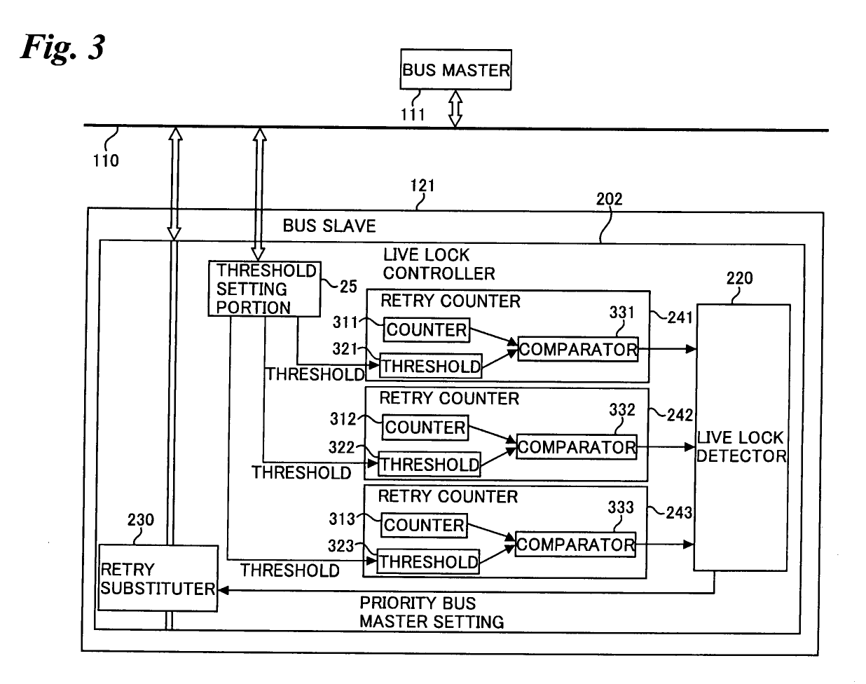

FIG. 3 shows an example of the configuration of the bus control system 100 where a threshold is set from the external bus master 111. As shown in FIG. 3, the bus control system 100 includes a threshold setting portion 25.

The threshold setting portion 25 writes threshold data as a threshold set value to the threshold registers 321 to 323 according to the address assigned to the registers 321 to 323. The threshold setting portion 25 may be placed as an external device of the live-lock controller 202.

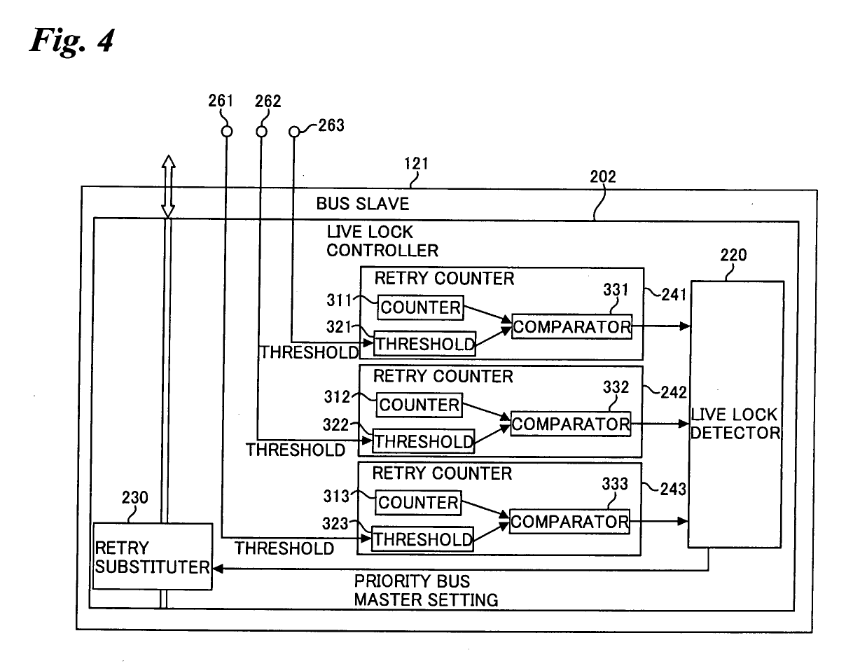

FIG. 4 shows an example of the configuration of the bus control system 100 where a threshold is set through an external terminal. As shown in FIG. 4, the bus control system 100 includes external terminals 261 to 263. In this configuration, the external terminals 261 to 263 are connected to an external device so that a threshold is set directly from the external device.

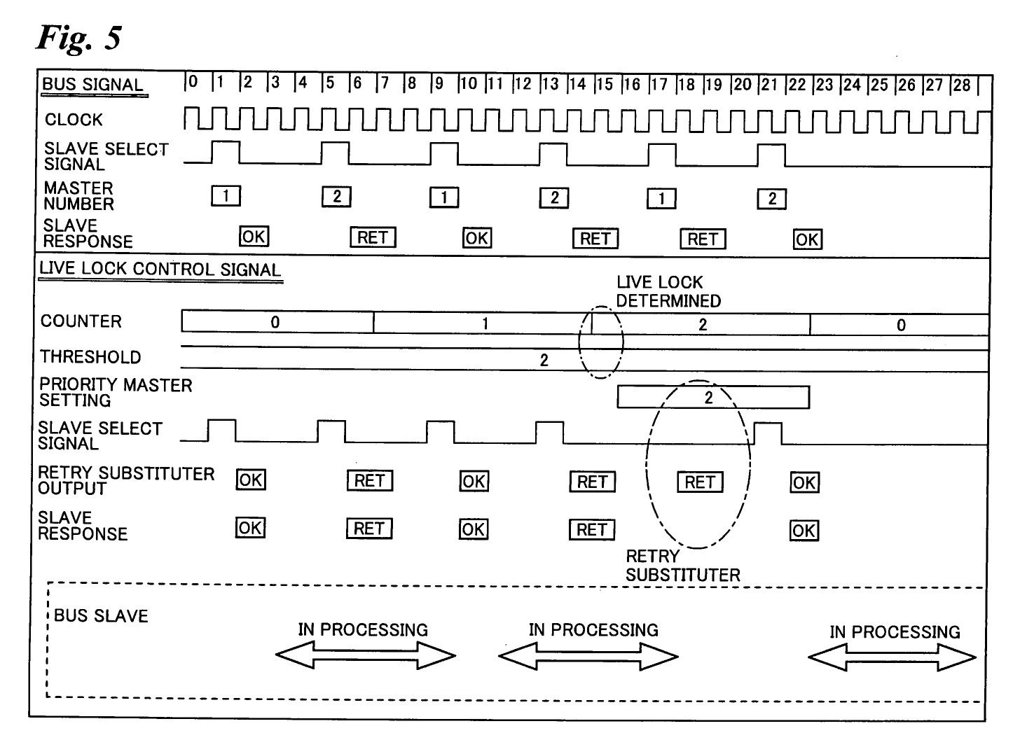

Referring now to FIG. 5, a series of operation of the bus control system 100 according to this embodiment is described hereinafter. FIG. 5 is an example of a timing chart showing the operation of the bus control system 100. The operation is described hereinbelow by referring to FIG. 2 as needed.

Firstly, the bus masters 111 to 113 make an access request to the bus slave 121. Each time the bus slave 121 sends back a RETRY response, the retry detector 210 outputs a count signal to the retry counter 241 corresponding to the bus master 111 according to a bus master number. In the example of FIG. 5, the bus master 111 corresponds to the bus master number “2”, and the bus master 112 corresponds to the bus master number “1”.

Receiving the count signal, the retry counter 241 counts up the counter 311. In the example of FIG. 5, each time the RETRY response is sent in response to the access request from the bus master 111 corresponds to the bus master number “2”, the counter 311 counts up from “0” to “1” to “2”. The comparator 331 compares a count-up value of the counter 311 with a threshold of the threshold register 321 to determine if they match. In the example of FIG. 5, a threshold “2” is set to the threshold register 321.

If the comparator 331 determines that the value of the counter 311 and the threshold of the threshold register 321 match, it determines that the live-lock condition is satisfied and supplies a signal indicating the determination result to the live-lock detector 220. In the example of FIG. 5, the comparator 331 determines that the live-lock condition is satisfied when the counter 311 counts “2”, which matches with the threshold “2”.

The live-lock detector 220 receives the signal from the comparator 331 in the retry counter 241. Then, the live-lock detector 220 sets the priority setting to the retry substituter 230 so that the bus master 111 takes precedence over the bus slave logic 201. In the example of FIG. 5, because the priority bus master setting is “2”, the bus master 111 with the bus master number “2” can transfer data in preference to the bus master 112 with the bus master number “1”.

After the priority bus master setting is on, the retry substituter 230, on behalf of the bus slave logic 202, sends a RETRY response in response to access requests from the bus masters other than the bus master 111 which possesses priority. The access request to the slave logic 202 from the bus masters 112 and 113 which do not possess priority is thereby always responded with a RETRY response. In the example of FIG. 5, the bus master 112 with the bus master number “1” receives a RETRY response. At this time, the retry substituter 230 masks a bus slave select signal so that the output of the RETRY response is not notified to the bus slave logic 201. Therefore, the bus slave logic 201 does not make any response as shown in FIG. 5.

When the bus master 111 which possesses priority makes an access request to the bus slave logic 202, the retry substituter 230 lets the access request through to the bus slave logic 202. The bus slave logic 202 thereby receives the data transferred from the bus master 111. If the access request from the bus master 111 which possesses priority is accepted, the retry detector 210 resets the retry counter 241 to “0”.

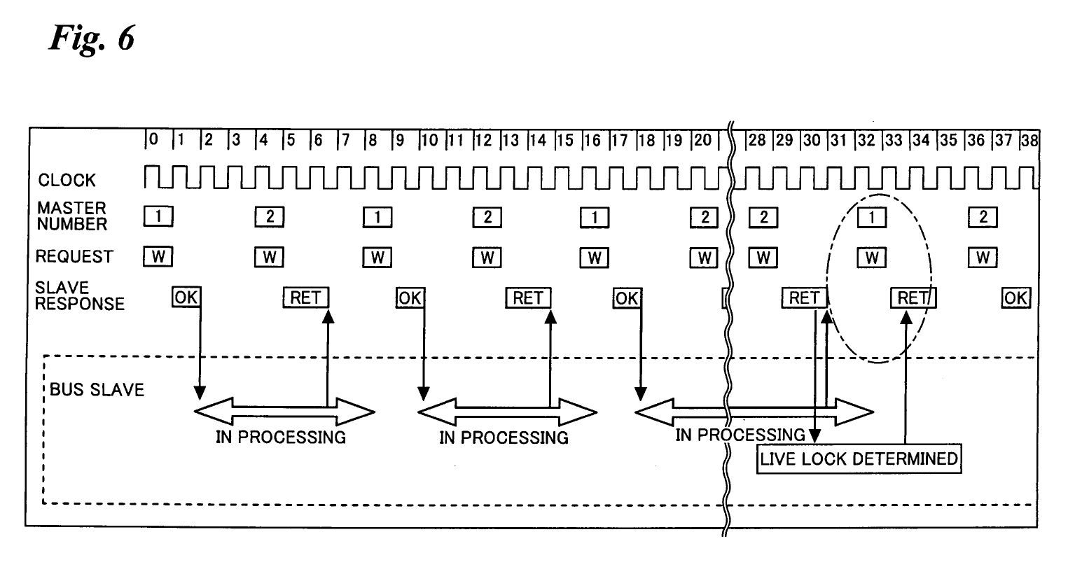

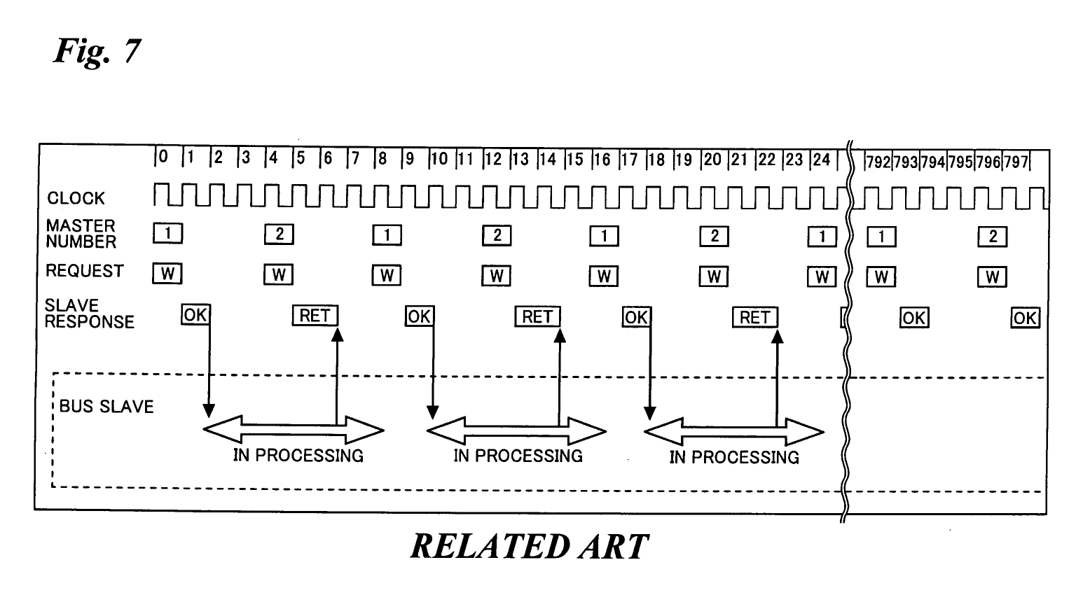

Referring then to FIGS. 6 and 7, a comparison is made between the bus control system 100 of this embodiment and a conventional bus system.

FIG. 6 shows a timing chart of data transfer in the bus control system 100 according to this embodiment. In the example of FIG. 6, each of the bus masters 111 and 112 makes an access request every 8 clocks. The value “4” is set to the bus slave 121 as a threshold of the number of RETRY attempts by the bus master 111.

FIG. 6 shows the case where the bus master 112 (master number 1) alone makes an access request for four times by way of illustration. In such a case, the bus slave 121 determines that live-lock is occurring when the bus master 111 (master number 2) is responded with RETRY for four times. Then, the bus slave 121 grants priority to the bus master 111 (master number 2). The request from the bus master 112 (master number 1) is responded with RETRY, and thereby the request from the bus master 111 (master number 2) is accepted by the bus slave 121. The number of clocks until the request from the bus master 111 (master number 2) is processed is 33 (8*4+1). A time period taken therefore is 0.33 μs if a bus frequency is 100 MHz.

FIG. 7 shows a timing chart of data transfer in a conventional bus system. In this bus system, no measures are taken to deal with live-lock. In the example of FIG. 7 also, each of the bus masters 111 and 112 makes an access request every 8 clocks.

As shown in FIG. 7, if live-lock occurs and the bus master 112 (master number 1) alone obtains a bus access right for 100 times in a row, the number of clocks until the request of the bus master 111 (master number 2) is accepted is 804 (100*8+4) clocks. A time period taken therefore is 8.04 μs if a bus frequency is 100 MHz.

As described above, the bus control system 100 of this embodiment prevents live-lock by the live-lock controller 202 of the bus slave 121. Specifically, the bus slave 121 grants priority to the bus master 112 which has not transferred data to the bus slave 121 for a long period of time so that the bus master 112 can transfer data. However, the bus master 112 which possesses priority to access the bus slave 121 does not possess an exclusive use right of the bus. Therefore, the bus master 113 which does not possess priority to access the bus slave 121 can still make an access request to the other bus slaves 122 and 123. This positively increases the data transfer efficiently.

Further, in the bus control system 100 of this embodiment, if the same function as that of the live-lock controller 202 is added to the bus slaves 122 and 123, for example, a threshold of each bus master 111 to 113 can be set for each of the bus slaves 121 to 123. This allows flexible setting of conditions for determining the occurrence of live-lock for each of the bus slaves 121 to 123 by setting a threshold in consideration of the characteristics of each bus master 111 to 113 and the bus slave 121 to 123. Furthermore, in the system where the live-lock prevention function is needed only for the bus slaves 121 and 122, for example, the live-lock can be prevented simply by adding the live-lock circuit 202 to the bus slaves 121 and 122 only.

In addition, in the bus control system 100 of this embodiment, it is possible to use a conventional bus slave, bus master, arbiter, and bus without making any change thereto when adding the live-lock controller 202 to the system. For example, live-lock on the bus slave logic 201 can be prevented simply by connecting the live-lock controller 202 to the bus slave 121, and there is no need to make any change to the bus slave logic 201. It is therefore possible to use a conventional bus slave function as it is and thus easily deal with live-lock.

Second Embodiment

According to a second exemplary embodiment of the present invention, the bus slaves in need of prevention of live-lock may use one live-lock controller in common. In such a case, the bus slaves which share a live-lock controller each have a retry substituter. The other configuration is the same as in the first embodiment and thus not described hereinbelow.

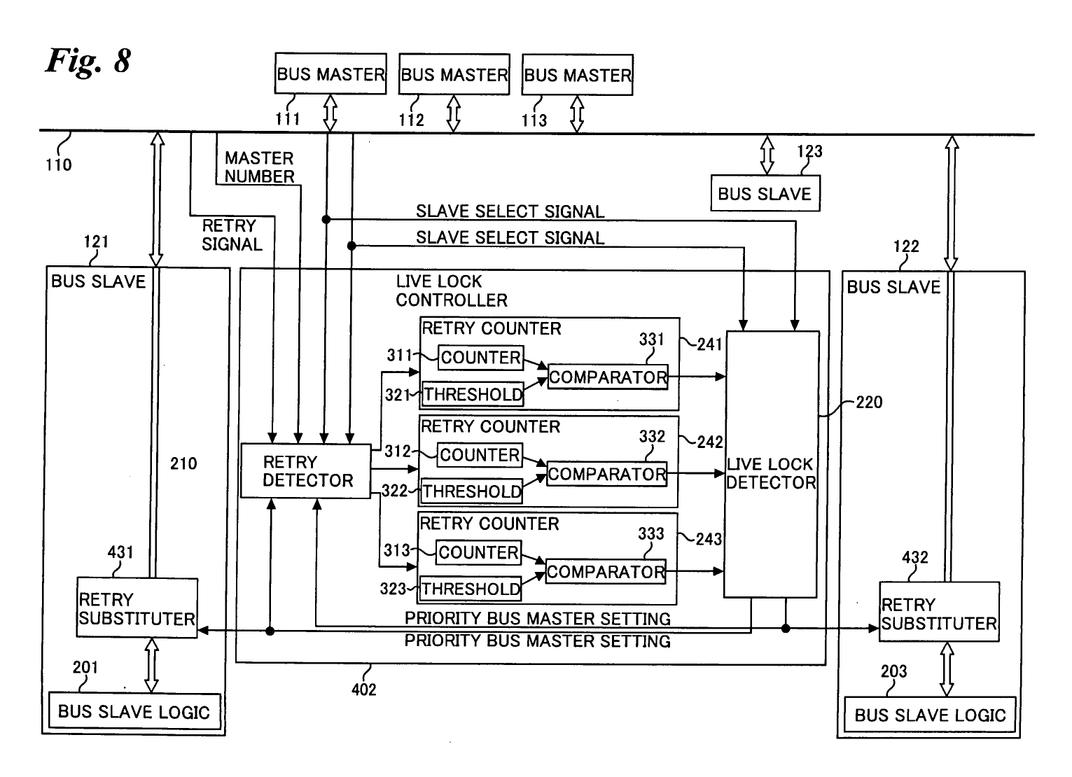

FIG. 8 shows an example of the configuration of the live-lock controller 402 in the second embodiment. In FIG. 8, the same functional blocks as in the first embodiment are denoted by the same reference numerals.

As shown in FIG. 8, the live-lock controller 402 is configured independently from the bus slaves 121 and 122 and used in common by the bus slaves 121 and 122. The bus slaves 121 and 122 respectively have retry substituters 431 and 432 which have the same function as the retry substituter 230. In the example of FIG. 8, the bus slave 122 has a bus slave logic 203.

In the second embodiment, a bus slave select signal corresponding to a bus slave is input to the retry detector 210. Specifically, a bus slave select signal for selecting the bus slave 121 and a bus slave select signal for selecting the bus slave 122 are input to the retry detector 210.

If the bus slaves 121 and 122 send a RETRY response repeatedly, the counters 311 to 313 of the retry counters 241 to 243 count up. The counters 311 to 313 do not count when priority bus master setting of the bus slaves 121 and 122 is input to the retry detector 210.

When the live-lock detector 220 receives a signal from the comparators 331 to 333, it implements priority bus master setting to the bus slave 121 or 122. Upon input of the bus slave select signal for the bus slave 121, the live-lock detector 220 outputs the priority bus master setting corresponding to the bus slave 121. Likewise, upon input of the bus slave select signal for the bus slave 122, the live-lock detector 220 outputs the priority bus master setting corresponding to the bus slave 122.

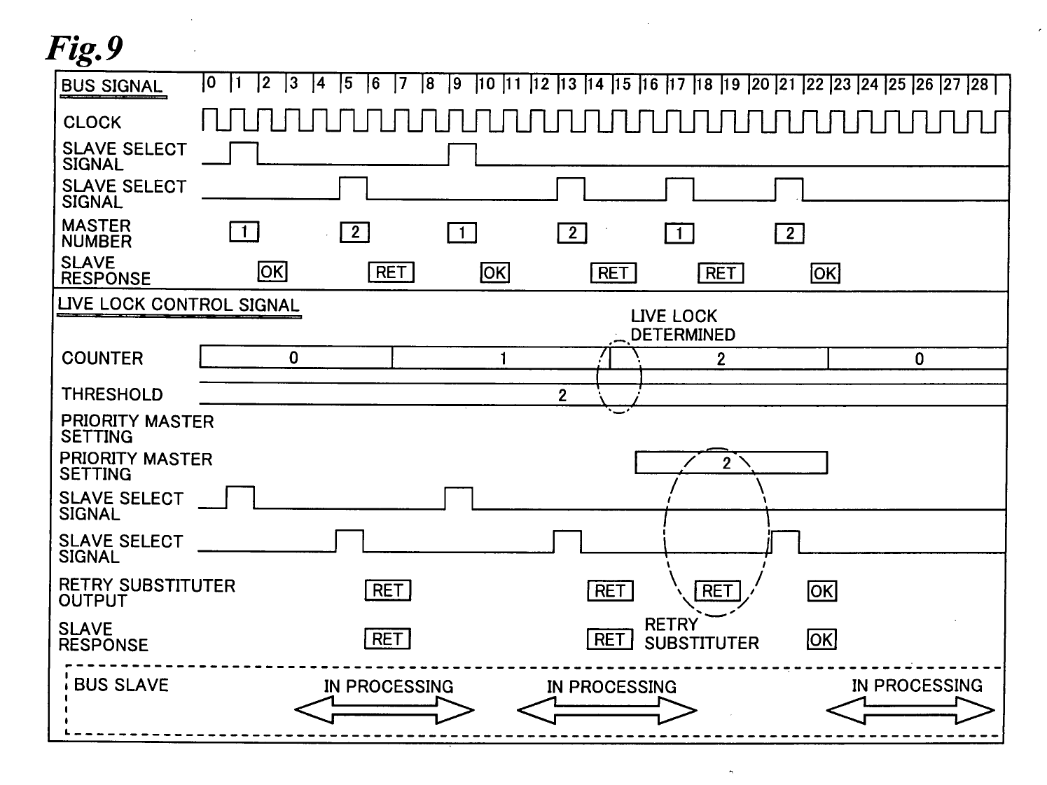

In such a bus control system according to the second embodiment, a series of operation is executed in the same manner as in the bus control system according to the first embodiment. The timing chart of FIG. 9 shows the operation of the bus control system according to the second embodiment.

Specifically, an access request to the bus slaves 121 and 122 is made from the bus masters 111 to 113 and the bus slave 121 sends back a RETRY response, for example. In such a case, the functional blocks such as the retry detector 210 perform the processing in the same way as in the first embodiment, and the retry substituters 431 and 432 with the priority bus master setting implement priority setting for the bus masters 111 to 113. For example, as shown in FIG. 9, the retry substituter 431 grants priority to the bus master 111 according to a slave select signal input through the bus 110. While the bus master 111 possesses priority, the retry substituter 431 masks the bus slave select signal if the bus masters 112 and 113 which are not the priority bus master intend to transfer data so as to operate as if no access is made to the bus slave 121.

In this way, if the live-lock controller 402 is shared as in this embodiment, the same threshold can be set for the bus slaves 121 and 122 as the live-lock condition for the bus masters 111 to 113. This enables reduction in circuit size.

Other Embodiments

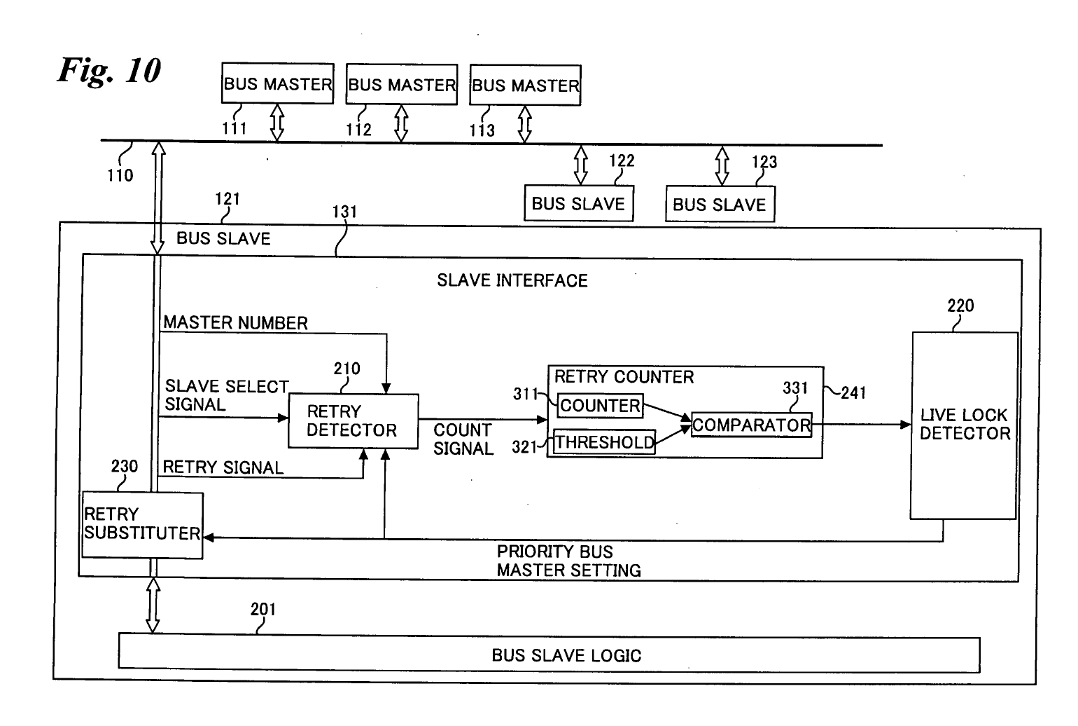

Though the live-lock controllers 202 and 402 are added in the first and second embodiments as described above, it is possible to configure a live-lock controller having a different structure for each of the bus slaves 121 to 123. FIG. 10 shows an example of the configuration according to a third exemplary embodiment. In FIG. 10, the same functional blocks as in the first and second embodiments are denoted by the same reference numerals.

Further, the configuration of FIG. 10 includes only one retry counter 241 so as to prevent live-lock on the bus master 111 only. In this way, it is possible to control live-lock only where it is necessary. This enables reduction in circuit size like the second embodiment.

It is apparent that the present invention is not limited to the above embodiment that may be modified and changed without departing from the scope and spirit of the invention.

What is claimed is:

1. A bus control system comprising:
a plurality of bus masters connected to a common bus;
a bus slave transferring data with the plurality of bus masters through the common bus; and
a controller counting a retry response to each of the plurality of bus masters for the respective bus masters and setting priority for preferentially accepting an access request from a selected bus master according to a count value.

2. The bus control system according to claim 1, wherein the controller includes a retry counter counting a retry response to each of the plurality of bus masters for the respective bus masters.

3. The bus control system according to claim 1, wherein the controller includes a retry substituter, upon receipt of an access request from a bus master different from the selected bus master to which the priority is set, sending a retry response to the bus master.

4. The bus control system according to claim 2, wherein the controller includes a retry substituter, upon receipt of an access request from a bus master different from the selected bus master to which the priority is set, sending a retry response to the bus master.

5. The bus control system according to claim 1, wherein the controller is included in the bus slave.

6. The bus control system according to claim 5, wherein the controller is connected to a bus slave logic for controlling operation of the bus slave and, upon receipt of an access request from the selected bus master to which the priority is set, transfers the access request to the bus slave logic.

7. The bus control system according to claim 1, wherein the controller is composed of a control circuit configured separately from a bus slave logic for controlling operation of the bus slave.

8. The bus control system according to claim 1, wherein the controller is included in an interface circuit of the bus slave.

9. The bus control system according to claim 1, further comprising:
another bus slave different from the bus slave, connected to the common bus,
wherein the controller is connected to the another bus slave and controls data transfer between the bus masters and the bus slave and data transfer between the bus masters and the other bus slave.

10. The bus control system according to claim 1, further comprising:
another bus slave different from the bus slave, connected to the common bus, the another bus slave configured separately from the controller and including another controller for controlling data transfer with the bus masters,
wherein the another controller counts a retry response to the bus masters and sets priority for preferentially accepting an access request from a selected bus master.

11. The bus control system according to claim 9, wherein the another controller includes another retry substituter configured separately from the retry substituter and, upon receipt of an access request from a bus master different from the selected bus master, sending a retry response to the bus master.

12. The bus control system according to claim 10, wherein the another controller includes another retry substituter configured separately from the retry substituter and, upon receipt of an access request from a bus master different from the selected bus master, sending a retry response to the bus master.

13. A bus control system comprising:
a first bus master and a second bus master connected to a common bus;
a bus slave transferring data with the first bus master or the second bus master through the common bus; and
a controller connected to the bus slave, controlling the transfer of data, the controller counting a retry response to the first bus master and sets priority for preferentially accepting an access request from the first bus master according to a count value, and, upon receipt of an access request from the second bus master when the priority is set to the first bus master, sending a retry response to the second bus master.
